(19) United States
(12) Patent Application Publication
(10) Pub. No.: US 2018/0302405 A1
(43) Pub. Date: Oct. 18, 2018

(54) ORGANIZATIONAL SIGN-IN ACROSS SOVEREIGN ENVIRONMENTS

(71) Applicant: Microsoft Technology Licensing, LLC, Redmond, WA (US)

(72) Inventors: Ariel GORDON, Kirkland, WA (US); Paul GARNER, Seattle, WA (US); Ben VINCENT, Kirkland, WA (US)

(21) Appl. No.: 15/490,675

(22) Filed: Apr. 18, 2017

(51) Int. Cl. H04L 29/06

(52) U.S. Cl. CPC H04L 63/0884; H04L 63/0853; H04L 63/083

(57) ABSTRACT

A system of a primary cloud for signing in users is provided. The system receives a sign-in request for a user that includes a personal identifier (e.g., phone number). The system performs a verification based on the personal identifier to authenticate the user. The system identifies, from a mapping, an entity to which the personal identifier is mapped. When the entity is associated with an external cloud, the system sends a sign-in request to the external cloud for authentication by the external cloud. When the entity is associated with an internal tenant, the system retrieves user information relating to the user and creates a security token based on the user information. If verification of the user was successful, the system sends the security token to the sign-in portal as evidence that the user has been authenticated.

### BACKGROUND

Many applications, or more generally services, maintain accounts for users. For each account, a service typically maintains a separate set of information. For example, an electronic mail service stores emails sent and received using each account. When creating an account for a user, the user provides credentials such as a user principal name (e.g., electronic mail address) and password. The user principal name (“UPN”) typically uniquely identifies the account, and the password is used to authenticate the user when the user later signs in to the account.

Many services hosted by a cloud computing system (also referred to as a cloud) employ an identity provider service provided by the infrastructure of the cloud to perform the authentication of users. When an account is created, the service directs the user to the identity provider service to input their UPN and password for the account. The identity provider service maintains a database or user store of user credentials for the service. When the user subsequently wants to access the account, the service directs the user to the identity provider service. The user provides the credentials to the identity provider service. The identity provider service verifies the credentials against those in the database. If the credentials are verified, the identity provider service provides to the service a security token for the account (e.g., indirectly via the device of the user). The security token is signed by the identity provider service and is evidence that the user has been authenticated as providing the proper credentials for the account. The service can check the signature of the security token to determine that it was signed by the identity provider service and check the content of the security token to confirm that the user has been authenticated. The service then allows the user to access the account.

In a cloud computing system, the services of many different organizations may be hosted. Such organizations are referred to as tenants of the cloud computing system. An example tenant may be a home improvement company that has retail stores. The cloud computing system may host an inventory application for the home improvement company for its retail employees to access inventory information via kiosks (e.g., computers with Internet access) within the stores. To access the inventory application, an employee would need to sign in to the inventory application. In some cases, tenants delegate the sign-in process to a sign-in portal of the cloud computing system. When the sign-in portal is used, an account would need to be created with a sign-in portal for each employee that needs to access the inventory application. The user principal name for an account may be an electronic mail address such as “john.doe@hic.com” where “hic.com” is the domain name of the home improvement company. The sign-in portal may delegate the authentication to an identity provider service of the cloud computing system. So, when an employee requests to sign-in the request is redirected to the identity provider service. The identity provider service can identify the tenant from the domain name and access the user store for the home improvement company to authenticate the employee based on the credentials. The identity provider then sends a security token for the employee to the sign-in portal to be used as evidence by the inventory application that the employee has been authenticated.

The use of credentials such as a UPN and password presents difficulties in certain situations. For example, during the springtime, the home improvement company may hire many seasonal workers. Although an account with a UPN and password may be created for each seasonal worker, such workers often have difficulty remembering their credentials. As another example, in some organizations, many of the employees may be considered “deskless” workers. A deskless worker is a worker who does not have a desk with a computer, such as a construction worker, a wait person, and so on. These deskless workers may still need to access certain applications of the organization, such as scheduling or payroll applications. These deskless workers may access their accounts so infrequently that it may be difficult for them to remember their credentials. When workers forget their credentials, it may lead to dissatisfied customers, loss of productivity, loss of revenue, and so on.

Some providers of cloud computing systems may provide a primary (or world-wide) cloud that interfaces with multiple external clouds. One of the reasons for having external clouds is to help satisfy the jurisdictional, organizational, and user requirements. For example, a research and development lab that is supported by a government of a country may want to use a cloud computing system for storing and processing its data. The government, however, may require for security reasons that all computing systems of the lab be housed within the country, for example, for security reasons or to promote industry within the country. As another example, a company of that same country may want to use a cloud computing system, but does not want to be subject to the jurisdiction of other countries. For example, other countries may have taxation laws that the company considers to be unfair, privacy laws that are inconsistent with that of their own country, and so on. Although it would be easier for a cloud provider to have one cloud to support tenants in all countries, such an approach would not meet the compliance needs of all tenants.

Although each country could have its own isolated cloud, there are features of a world-wide cloud that tenants of that isolated cloud would be like to take advantage of. For example, a tenant of an isolated cloud may have employees throughout the world who need access not only to the services of the isolated cloud but also the vast amount services provided by a word-wide cloud. Indeed, the company may want to also be a tenant of the world-wide cloud. To facilitate the integration of isolated clouds with a world-wide cloud, the world-wide cloud may support redirecting sign-in requests that it receives to the various external clouds. In this way, a user with an account with a tenant of an external cloud can use the sign-in portal or the identity provider service of the word-wide cloud to initiate a sign-in request. The external cloud may provide to the identity provider service of the primary cloud a list of its UPNs of its users. When the primary cloud receives a sign-in request with a UPN that is on the list, it redirects the sign-in request to an external identity provider service of the external cloud. The external identity provider service can then receive credentials directly from the user and authenticate the user. The use of credentials such a UPN and password for signing in has the same difficulties as discussed above.

### SUMMARY

A method and system performed by a computing system of a primary cloud for signing in using personal identifiers (e.g., phone numbers) input via a sign-in portal that supports multiple tenants is provided. The system receives a sign-in request for a user that includes a personal identifier. The personal identifier uniquely identifies a person but does not include an identification of a tenant. The system performs a verification based on the personal identifier to authenticate the user. The system identifies, from a mapping, a tenant or an external cloud to which the personal identifier is mapped. The mapping maps personal identifiers of users to tenants and external clouds. When the mapping is not to an external cloud, the system retrieves, from a user store for the mapped-to tenant, user information relating to the user. The system then creates a security token based on the user information. If verification of the user was successful, the system sends the security token to the sign-in portal as evidence that the user has been authenticated. When the mapping is to an external cloud, the system sends a sign-in request to the external cloud for authentication of the user by the external cloud. The external cloud can then perform its own authentication and allow access to a tenant of the external cloud. In this way, a user can sign-in to an account of a tenant of the external cloud using their personal identifier, even though the user accessed a sign-in portal of the primary cloud or an application used by the user requested to sign in via the primary cloud.

This Summary is provided to introduce a selection of concepts in a simplified form that are further described below in the Detailed Description. This Summary is no intended to identify key features or essential features of the claimed subject matter, nor is it intended to be used to limit the scope of the claimed subject matter.

### BRIEF DESCRIPTION OF THE DRAWINGS

FIG. 1 illustrates user experience elements of the PI-IP system in some embodiments.

FIG. 2 is a block diagram that illustrates components of the PI-IP system in some embodiments.

FIG. 3 is a flow diagram that illustrates the processing of an add phone number authentication component in some embodiments.

FIG. 4 is a flow diagram that illustrates the processing of an authenticate component of the PI-IP system in some embodiments.

FIG. 5 is a flow diagram that illustrates the processing of a phone number authenticate component of the PI-IP system in some embodiments.

### DETAILED DESCRIPTION

A method and system are provided for authenticating users based on personal identifiers that are unique to each person and are tenant-independent. For example, a phone number is a personal identifier that uniquely identifies the person in possession of the telephone with that number. Also, a personal electronic mail address is a personal identifier that uniquely identifies the person with knowledge of the credentials for the electronic mail account. A phone number and personal electronic mail address are also tenant-independent in that they do not by themselves uniquely identify a tenant, which is in contrast to a corporate electronic mail address with a domain name that can uniquely identify a tenant.

In some embodiments, a personal identifier identity provider (“PI-IP”) system or service allows users to sign in to accounts of tenants using their personal identifiers rather than using the credentials, such as a UPN and password, that are associated with their accounts. The PI-IP system may provide a feature through which a user can associate their personal identifier with their account. For example, when a seasonal worker is provided with their UPN and password, the worker may access a management feature of the PI-IP system to associate their cell phone number with their account. The PI-IP system may maintain a mapping of each phone number to the tenants that the phone number is associated with. For example, a worker who works part-time for both a coffee shop and a restaurant may associate their phone number with an account of the coffee shop and an account of the restaurant when the coffee shop and restaurants are both tenants.

In some embodiments, a PI-IP system that is part of a primary cloud (“primary PI-IP system”) is responsible for redirecting sign-in requests that it receives to a PI-IP system of an external cloud (“external PI-IP system”). To support such redirecting, the primary PI-IP system maintains a mapping of phone numbers of users with accounts with tenants of the external cloud (“external tenants”) to either the external cloud or both the external cloud and the external tenant. The term “entity” is refers to what a phone number is mapped to, that is, a tenant of the primary cloud (“primary tenant”), an external cloud, or an external tenant/external cloud combination. So, each phone number is mapped to an entity. When a user of the external cloud associates their phone number with an account of an external tenant, the external PI-IP system stores a mapping of the phone number to the external tenant and also provides to the primary PI-IP system an indication that the phone number is mapped to an external tenant. The primary PI-IP system and the external PI-IP system thus interact to ensure that the mapping of the internal PI-IP system is synchronized with the mapping of the external PI-IP system. The mapping of the primary PI-IP system, however, need only indicate that a phone number is associated with the external cloud and does not need to also be mapped to an external tenant.

When a user requests to sign in via a sign-in portal, the sign-in portal may redirect the request to the PI-IP system. Upon receiving a sign-in request, the PI-IP system sends a sign-in user experience element (e.g., a dialog box) to the device of the user, which may prompt the user to enter their credentials or phone number. If the user enters their credentials, then the PI-IP system may authenticate the user using conventional techniques. If, however, the user enters their phone number, the PI-IP system authenticates the user using a phone-based authentication. The PI-IP system may help ensure privacy by not indicating in the sign-in user experience element whether the phone number is associated with an account. For example, the sign-in user experience element could say something like “If the phone number is registered, then a verification code is being sent addressed to that phone number.” In this way, a person knowing the phone number cannot determine whether the phone number is associated with an account of a tenant of the cloud unless the person also is in possession of the phone with that phone number.

In some embodiments, to perform a phone-based authentication, the PI-IP system performs a phone-based verification using the phone number to authenticate the user. For example, the PI-IP may send a verification code via a messaging service addressed to the phone number such as via a short message service or a voice call and send a verification user experience element to the device through which the user entered their phone number. Upon receiving the verification code, the user enters the verification code via the verification user experience element to send the verification code to the PI-IP system. If the received verification code matches the one that was sent, then the PI-IP system has authenticated the user as having possession of the phone.

In some embodiments, after the user has been authenticated, the operation of the primary PI-IP system is the same as the operation of the external PI-IP system when processing phone numbers of local tenants. Local tenants of a cloud are the tenants hosted by that cloud. In general, the operations that are described as being performed by a PI-IP system are performed by both the primary PI-IP system and the external PI-IP system when processing phone numbers associated with their local tenants. The PI-IP system then may determine whether the user has an account with a tenant by checking a mapping of phone numbers to tenants. If the phone number is associated with a tenant, then the PI-IP system retrieves user information for an account from a user store for the tenant. The PI-IP system may then generate and send a security token to the sign-in portal (e.g., via the device, which redirects the security token to the sign-in portal). The sign-in portal can then complete the signing in of the user based on the authentication provided by security token.

In some embodiments, when a phone number is mapped to the external cloud, the primary PI-IP system performs processing that is different from the processing described above for local tenants. After the user has been authenticated by the primary PI-IP system and when the phone number is mapped to the external cloud, the primary PI-IP system sends a sign-in request (e.g., via the device of the user) to the external PI-IP system. When the external PI-IP system receives the sign-in request, it authenticates the user as described above by sending a sign-in user experience element and, upon receiving a phone number, performing a phone-based authentication. Thus, the primary PI-IP system and the external PI-IP system may perform separate phone-based authentications of the user as described above. When the primary PI-IP system sends the sign-in request to the external PI-IP system, it may include the phone number. In this way, the external PI-IP system need only perform the phone-based verification based on that phone number and need not send a sign-in user experience element to the user. Alternatively, the primary PI-IP system could simply redirect the sign-in request to the external PI-IP system upon receiving a phone number that is mapped to the external cloud without performing a phone-based authentication. This alternative approach, however, may raise some privacy issues as any person knowing a phone number could determine if that phone number was associated with the external cloud.

In some embodiments, if the phone number is associated with multiple tenants, the PI-IP system may send a tenant selection user experience element to the user that lists the tenants and requests the user to select a tenant. The user can then select the tenant (e.g., coffee shop or restaurant) that the user wants to sign in to. To help preserve the privacy of the user, the PI-IP system may not send the selection user experience element until the user has been verified using the phone-based verification. If the PI-IP system were to send the tenant selection user experience element before the phone-based verification, then anyone in possession of the phone number could determine the tenants with which the user had an account, which may present privacy concerns. More generally, with the primary PI-IP system, a phone number may be associated with multiple entities that can include local tenants and one or more external clouds. In such a case, the primary PI-IP system sends an entity user element experience to allow the user to select a local tenant if any or an external cloud.

Although the PI-IP system is described primarily in the context of using a phone number as the personal identifier, other personal identifiers can be used. For example, the personal identifier can be a personal electronic mail address, a government-issued identifier (e.g., electronic identifier, social security number, passport number, or driver's license number), a user-created unique identifier, a scanned code (e.g., a Quick Response code), and so on. Preferably, the personal identifier is easy for the user to remember. After a personal identifier is received, the PI-IP system may access the user store of the tenant to identify a mode for sending the verification code for the account associated with the phone number. For example, the mode may be an electronic mail address for sending a verification code or a phone number for sending the verification code via a short message service or a voice call.

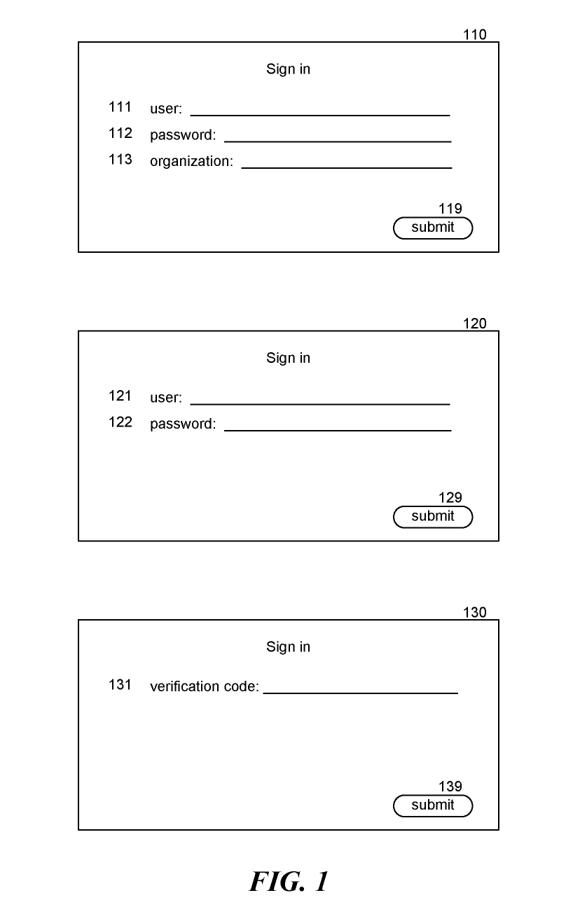

FIG. 1 illustrates user experience elements of the PI-IP system in some embodiments. A user experience element 110 is sent to a device of the user for input of the credentials. The user experience element 110 includes a user entry field 111, a password entry field 112, an organization entry field 113, and a submit button 119. The user experience element 110 allows the user to sign in by entering the UPN in the user entry field and password in the password entry field or a phone number in the user entry field without entering a password. The user experience element 110 allows the user to also specify an organization or tenant via the organization entry field in case the user has accounts with multiple tenants. The user then selects a submit button to submit the sign-in information.

A user experience element 120 is sent to a device of the user for input of the credentials and provides a simplified version of the user experience element 110. The user experience element 120 includes a user entry field 121, a password entry field 122, and a submit button 129. The user experience element 120 allows the user to sign in using a UPN and password or a phone number. The user experience element 120 does not allow the user to also specify an organization or tenant. Thus, if the user has accounts with multiple tenants, then PI-IP system will request the user to select a tenant after the phone-based verification. The user then selects a submit button to submit the sign-in information.

A user experience element 130 is sent to a device of the user for input of a verification code. The user experience element 130 includes a verification code entry field 131 and a submit button 139. Upon receiving a verification code, the user enters the verification code into the verification code entry field and selects the submit button.

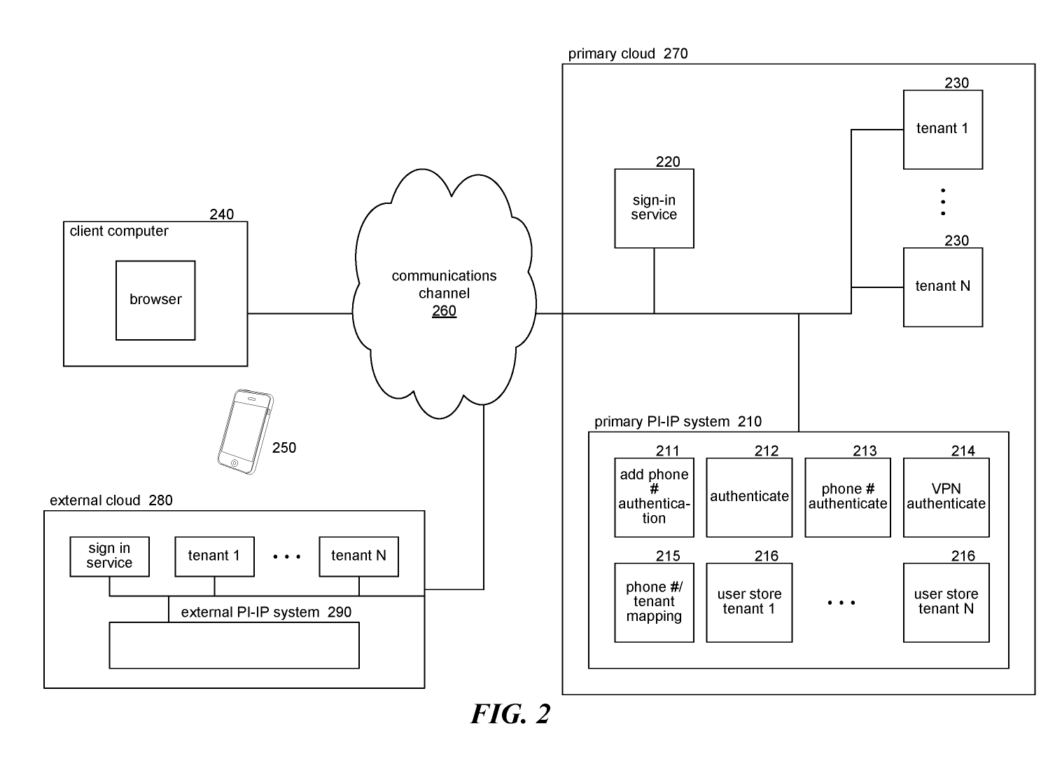

FIG. 2 is a block diagram that illustrates components of the PI-IP system in some embodiments. A primary cloud 270 includes a primary PI-IP system 210, a sign-in service 220, and various tenant systems 230 that are hosted on servers of the primary cloud. An external cloud 280 includes an external PI-IP system 290, a sign-service, and tenant systems. The clouds may be connected to client computers 240 via a communications channel 260. The PI-IP systems may also be connected to a service (not illustrated) for sending short message service messages to phones such as phone 250. The primary PI-IP system includes an add phone number authentication component 211, an authenticate component 212, a phone number authenticate component 213, and a UPN authenticate component 214. The PI-IP system may also include a phone number to tenant mapping store 215 and, for each tenant, a user store 216. The external PI-IP system includes similar components and stores. As such, the external PI-IP system performs processing similar to the primary PI-IP system when a user attempts to sign in directly to the external PI-IP system or a user attempts to sign in via the primary PI-IP system, but is redirected to the external PI-IP system. The add phone number authentication component coordinates the associating of a phone number with an account of the tenant. The authenticate component performs the authentication of a user and invokes either the phone number authenticate component or the UPN authenticate component, depending on whether the user supplied a phone number or a UPN and password. The phone number to tenant mapping store may map each phone number to the UPN of an account and a tenant or simply to a tenant. If mapped only to a tenant, the PI-IP system may need to search the user store for the tenant for the account associated with the phone number. To speed up processing, the user store may maintain an index mapping phone numbers to accounts. Alternatively, the PI-IP system may not use the phone number to tenant mapping store. In such a case, the PI-IP system would need to search the user stores for the account associated with a phone number. The communications channel may be a network such as the Internet. In the case of the primary PI-IP system, the phone number to tenant mapping store may also maps phone numbers the external cloud. Although not illustrated, the primary PI-IP system and the external PI-IP system may have components to ensure that the phone number to tenant mapping of the primary PI-IP system is synchronized with that of the external PI-IP system. Specifically, the phone number to tenant mapping of the primary PI-IP system needs to map each phone number associated with an account of an external tenant that is authorized to be accessed initially via the primary cloud.

The computing systems, also referred to as computer systems, used by the PI-IP system may include a central processing unit, input devices, output devices (e.g., display devices and speakers), storage devices (e.g., memory and disk drives), network interfaces, graphics processing units, accelerometers, cellular radio link interfaces, global positioning system devices, and so on. A computing system may include multiple devices such as servers of a data center, massively parallel systems, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the PI-IP system. The data transmission media are used for transmitting data via transitory, propagating signals or carrier waves (e.g., electromagnetism) via a wired or wireless connection.

The PI-IP system may be described in the general context of computer-executable instructions, such as program modules and components, executed by one or more computers, processors, or other devices. Generally, program modules or components include routines, programs, objects, data structures, and so on that perform tasks or implement data types. Typically, the functionality of the program modules may be combined or distributed as desired in various embodiments. Aspects of the PI-IP system may be implemented in hardware using, for example, an application-specific integrated circuit (ASIC).

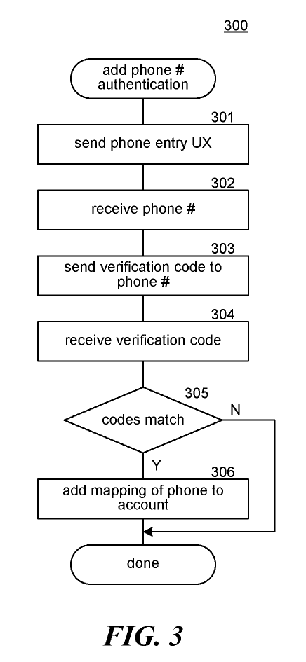

FIG. 3 is a flow diagram that illustrates the processing of an add phone number authentication component in some embodiments. An add phone number authentication component 300 is invoked to associate a phone number with an account of a tenant when requested by a user after the user has signed in to the account. In block 301, the component sends a phone number entry user experience element to the device of the user for entry of the phone number. In block 302, the component receives the phone number. In block 303, the component sends a verification code to the phone number. In block 304, the component receives the verification code that was input via a user experience element. In decision block 305, if the verification code that was sent matches the verification code that was received, then the component continues at block 306, else the component completes. In block 306, the component adds a mapping of the phone number to the account and then completes. When a mapping of a phone number to an account is added (or removed) by the external PI-IP system, the mapping of the primary PI-IP system needs to be updated.

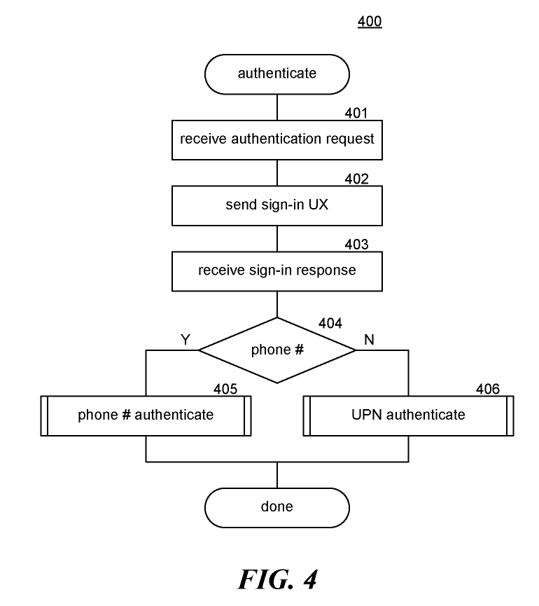

FIG. 4 is a flow diagram that illustrates the processing of an authenticate component of the PI-IP system in some embodiments. An authenticate component 400 is invoked when the PI-IP system receives an authenticate request from a sign in-portal. In block 401, the component receives the authentication request. In block 402, the component sends a sign-in user experience element for the user to enter their credentials or phone number. In block 403, the component receives the sign-in response. In decision block 404, if a sign-in response includes a phone number, then the component continues at block 405, else the component continues at block 406. In block 405, the component invokes a phone number authenticate component to authenticate the phone number and completes. In block 406, the component invokes a UPN authenticate component to perform conventional authentication and then completes.

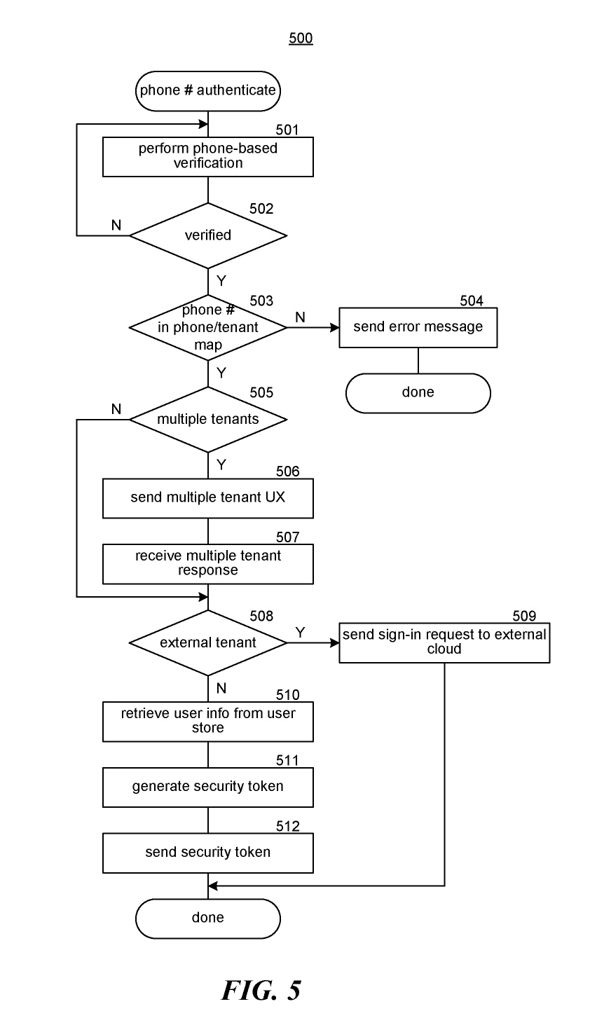

FIG. 5 is a flow diagram that illustrates the processing of a phone number authenticate component of the PI-IP system in some embodiments. A phone number authenticate component 500 is invoked when a user requests to be authenticated using a phone number. In block 501, the component performs a phone-based verification to verify that the user is in possession of the phone. In decision block 502, if the user is verified as being in possession of the phone, then the component continues at block 503, else the component loops to block 501 to retry the verification. In decision block 503, if the phone number is in the phone number to tenant mapping, then the component continues at block 505, else the component continues at block 504. In block 504, the component sends an error message to the user and then completes. In decision block 505, if the phone number is associated with multiple tenants, as indicated by the phone number to tenant mapping store, then the component continues at block 506, else the component continues at block 508. In block 506, the component sends a multiple tenant user experience element to the device of the user that requests the user to select one of the multiple tenants. In block 507, the component receives a multiple tenant response that identifies a tenant. In decision block 508, if the tenant (or actually entity) is for an external tenant, then the component continues at block 509, else the component continues at bock 510. In block 509, the component sends a sign-in request via the user's device to the external PI-IP system of that external cloud and then completes. When the external PI-IP system receives the sign-in request it invokes the authenticate component 400, which in turn invokes the phone number authenticate component 500 of the external PI-IP system. The phone number authenticate component of the external PI-IP system would then perform a re-verification of the user. Blocks 508 and 509 need only be included in the phone number authenticate component of the primary PI-IP system. Although the blocks could be included in that component of the external PI-IP system, block 509 would never be reached as the phone number to tenant mapping would typically not include a mapping to another external cloud. In block 510, the component retrieves user information from the user store for the tenant that is associated with the phone number. In block 511, the component generates a security token for the user associated with the account. In block 512, the component sends the security token to the sign-in portal to complete the sign-in of the user and then completes.

The following paragraphs describe various embodiments of aspects of the PI-IP system. An implementation of the PI-IP system may employ any combination of the embodiments. The processing described below may be performed by a computing device with a processor that executes computer-executable instructions stored on a computer-readable storage medium that implements the PI-IP system.

A method performed by a computing system of an identity provider service of a cloud is provided. The method receives a sign-in request for a user, the sign-in request including a personal identifier wherein the personal identifier uniquely identifies a person. The method performs a verification based on the personal identifier to authenticate the user. The method identifies from a mapping an entity to which the personal identifier is mapped. The mapping maps personal identifiers of users to entities. When the entity is associated with an external cloud and after successful verification of the user, the method redirects the sign-in request to an external identity provider service of the external cloud wherein the external identity provider service authenticates the user for access to the external cloud. In some embodiments, when the entity is a tenant of the cloud, the method retrieves, from a user store for the tenant, user information relating to the user. The method also creates a security token based on the user information. After successful verification of the user, the method sends the security token as evidence that the user has been authenticated. In some embodiments, the entity is a tenant of the external cloud. In some embodiments, the entity is the external cloud. In some embodiments, when the personal identifier is mapped to multiple entities, the method further receives from the user a selection of an entity for which the user is to be authenticated. In some embodiments, the personal identifier is a phone number. In some embodiments, the personal identifier is a personal electronic mail address. In some embodiments, the verification includes sending an electronic message to an address associated with the personal identifier. In some embodiments, the mapping maps personal identifiers to tenants within the cloud and to the external cloud for tenants of the external cloud. In some embodiments, the method further receives from the external cloud an indication of personal identifiers associated with accounts of tenants of the external cloud.

In some embodiments, a computing system of an identity provider service a cloud is provided. The computing system comprises one or more computer-readable storage media and one or more processors for executing the computer-executable instructions stored in the one or more computer-readable storage media. The storage media stores a mapping of personal identifiers to entities. Each personal identifier uniquely identifies a person. The storage media stores computer-executable instructions that, when executed, control the computing system to receive a sign-in request for a user, the sign-in request including a personal identifier. The instructions further control the computing system to send a verification request to the user via a service associated with the personal identifier. The instructions further control the computing system to identify from the mapping an entity to which the personal identifier is mapped. The instructions further control the computing system to, when the entity is associated with an external cloud and after successful verification of the user, redirect the sign-in request to an external identity provider of the external cloud. The redirecting allows the external identity provider to authenticate the user for access to the external cloud based on a mapping of personal identifiers to entities that is maintained by the external identity provider. In some embodiments, an entity that is not associated with an external cloud is a tenant of the cloud. In some embodiments, the instructions further control the computing system to retrieve, from a user store for the tenant, user information relating to the user and, after receiving a response to the verification request that verifies the user, send a security token as evidence that the user has been authenticated. In some embodiments, the instructions further control the computing system to, when the personal identifier is mapped to multiple entities, and after receiving the response to the verification request that verifies the user, receive from the user a selection of an entity for which the user is to be authenticated. In some embodiments, the computer-executable instructions further control the computing system to, when the personal identifier is mapped to multiple entities, and after receiving the response to the verification request that verifies the user, send to the user a request to select one of the multiple entities. In some embodiments, when an entity is a tenant of the cloud, the mapping of personal identifiers to an tenant is stored as part of the user store for that tenant. In some embodiments, the computer-executable instructions further control the computing system to create a security token based on the user information.

In some embodiments, one or more computer-readable storage media that store computer-executable instructions of a primary identity provider service of a primary cloud is provided. The computer-executable instructions comprise instructions to receive a sign-in request for a user, the sign-in request including a phone number. The computer-executable instructions comprise instructions to send a verification request via a messaging service associated with the phone number. The computer-executable instructions comprise instructions to identify, from a mapping of phone numbers to entities, an entity to which the phone number is mapped. The computer-executable instructions comprise instructions to, after receiving a response to the verification request that verifies the user and when the identified entity is associated with an external cloud, redirect the sign-in request to an external identity provider service of the external cloud so that the external identity provider service can authenticate the user for access to the external cloud. In some embodiments, the identified entity is a tenant that is not associated with an external cloud. In some embodiments, the computer-executable instructions further comprise instructions to retrieve, from a user store for the tenant, user information relating to the user and to, after receiving a response to the verification request that verifies the user, send to a service of the tenant a security token as evidence that the user has been authenticated. In some embodiments, the computer-executable instructions further comprise instructions to, when the phone number is mapped to multiple entities, and after receiving the response to the verification request that verifies the user, receive from the user a selection of an entity for which the user is to be authenticated. In some embodiments, the sign-in request is redirected when the selected entity is associated with the external cloud.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by a computing system of an identity provider service of a cloud, the method comprising:
receiving a sign-in request for a user, the sign-in request including a personal identifier wherein the personal identifier uniquely identifies a person;
performing a verification based on the personal identifier to authenticate the user;
identifying from a mapping an entity to which the personal identifier is mapped, wherein the mapping maps personal identifiers of users to entities; and
when the entity is associated with an external cloud and after successful verification of the user, redirecting the sign-in request to an external identity provider service of the external cloud wherein the external identity provider service authenticates the user for access to the external cloud.

2. The method of claim 1 further comprises:
when the entity is a tenant of the cloud,
retrieving, from a user store for the tenant, user information relating to the user;
creating a security token based on the user information; and
after successful verification of the user, sending the security token as evidence that the user has been authenticated.

3. The method of claim 1 wherein the entity is a tenant of the external cloud.

4. The method of claim 1 wherein the entity is the external cloud.

5. The method of claim 1 further comprising, when the personal identifier is mapped to multiple entities, receiving from the user a selection of an entity for which the user is to be authenticated.

6. The method of claim 1 wherein the personal identifier is a phone number.

7. The method of claim 1 wherein the personal identifier is a personal electronic mail address.

8. The method of claim 1 wherein the verification includes sending an electronic message to an address associated with the personal identifier.

9. The method of claim 1 wherein the mapping maps personal identifiers to tenants within the cloud and to the external cloud for tenants of the external cloud.

10. The method of claim 1 further comprising receiving from the external cloud an indication of personal identifiers associated with accounts of tenants of the external cloud.

11. A computing system of an identity provider service a cloud, the computing system comprising:
one or more computer-readable storage media storing:
a mapping of personal identifiers to entities, each personal identifier uniquely identifying a person; and
computer-executable instructions that, when executed, control the computing system to:
receive a sign-in request for a user, the sign-in request including a personal identifier;
send a verification request to the user via a service associated with the personal identifier;
identify from the mapping an entity to which the personal identifier is mapped; and
when the entity is associated with an external cloud and after successful verification of the user, redirect the sign-in request to an external identity provider of the external cloud so that the external identity provider can authenticate the user for access to the external cloud based on a mapping of personal identifiers to entities that is maintained by the external identity provider; and
one or more processors for executing the computer-executable instructions stored in the one or more computer-readable storage media.

12. The computing system of claim 11 wherein an entity that is not associated with an external cloud is a tenant of the cloud and wherein the computer-executable instructions further, when executed, control the computing system to:
retrieve, from a user store for the tenant, user information relating to the user; and
after receiving a response to the verification request that verifies the user, send a security token as evidence that the user has been authenticated.

13. The computing system of claim 11 wherein the computer-executable instructions further, when executed, control the computing system to, when the personal identifier is mapped to multiple entities, and after receiving the response to the verification request that verifies the user, receive from the user a selection of an entity for which the user is to be authenticated.

14. The computing system of claim 11 wherein the computer-executable instructions further, when executed, control the computing system to, when the personal identifier is mapped to multiple entities, and after receiving the response to the verification request that verifies the user, send to the user a request to select one of the multiple entities.

15. The computing system of claim 11 wherein when an entity is a tenant of the cloud, the mapping of personal identifiers to an tenant is stored as part of the user store for that tenant.

16. The computing system of claim 11 wherein the computer-executable instructions further, when executed, control the computing system to create a security token based on the user information.

17. One or more computer-readable storage media that store computer-executable instructions of a primary identity provider service of a primary cloud, the computer-executable instructions comprising:
instructions to receive a sign-in request for a user, the sign-in request including a phone number;
instructions to send a verification request via a messaging service associated with the phone number;
instructions to identify, from a mapping of phone numbers to entities, an entity to which the phone number is mapped; and
instructions to, after receiving a response to the verification request that verifies the user and when the identified entity is associated with an external cloud, redirect the sign-in request to an external identity provider service of the external cloud so that the external identity provider service can authenticate the user for access to the external cloud.

18. The one or more computer-readable storage media of claim 17 wherein the identified entity is a tenant that is not associated with an external cloud and wherein the computer-executable instructions further comprise
instructions to retrieve, from a user store for the tenant, user information relating to the user; and
instructions to, after receiving a response to the verification request that verifies the user, send to a service of the tenant a security token as evidence that the user has been authenticated.

19. The one or more computer-readable storage media of claim 17 wherein the computer-executable instructions further comprise instructions to, when the phone number is mapped to multiple entities, and after receiving the response to the verification request that verifies the user, receive from the user a selection of an entity for which the user is to be authenticated.

20. The one or more computer-readable storage media of claim 19 wherein the sign-in request is redirected when the selected entity is associated with the external cloud.
